(19) United States
(12) Patent Application Publication
(10) Pub. No.: US 2005/0275981 A1
(43) Pub. Date: Dec. 15, 2005

(54) GFCI wiring device with integral relay module

(76) Inventors: John J. Power, Westbury, NY (US); Armando Calixto, Floral Park, NY (US); Roger M. Bradley, North Bellmore, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/088,723

(22) Filed: Mar. 25, 2005

Related U.S. Application Data
(60) Provisional application No. 60/559,871, filed on Apr. 5, 2004.

(51) Int. Cl. H02H 3/00

(52) U.S. Cl. 361/42

(57) ABSTRACT

The present invention discloses an electrical wiring device having a GFCI in combination with an integral relay module with internally supported GFCI transformers to form a relatively small right angle plug that can be connected to a power conductor of an electrical device.

This application claims the benefit of the filing date of a provisional application having Ser. No. 60/559,871 which was filed on Apr. 5, 2004.

### BACKGROUND OF THE INVENTION

1. Field of the Invention

This invention relates generally to a wiring device and more specifically to a ground fault circuit interrupter (GFCI) wiring device in combination with an integral relay module.

2. Description of the Related Art

GFCIs are well known electrical devices in common use today. They are often used to help protect against electrical shock due to ground fault conditions. A GFCI is basically a differential current detector operative to trip a contact mechanism when a certain amount of unbalanced current is detected between the phase wire and the neutral wire of an alternating current (AC) electrical power line. A typical GFCI includes electrical components such as transformers, a relay and circuitry for detecting a ground fault condition which make it difficult to incorporate into various GFCI configurations. It would be desirable to have a compact GFCI module capable of being incorporated within various GFCI configurations.

### SUMMARY OF THE INVENTION

The present invention solves the above noted problems by providing a wiring device having a main housing for supporting a relatively small size relay module which is integral with internally supported GFCI transformers to form a relatively small right angle plug that can be connected to a power conductor of an electrical appliance such as power washer, hot tub or other device. A printed circuit board (PCB) containing circuitry for controlling the operation of the GFCI can be mounted within the main housing. The bottom portion of the main housing has a wiring chamber for connecting to a power conductor cable. The wiring chamber can be sealed with a back cover and the top portion of the main housing can be sealed with a top cover. The plug can be offered in several configurations such as 15 amp, 20 amp and 2 blade polarized configurations. The plug can be also configured as ground pin up or down versions. The plug can be assembled in layers to facilitate the manufacturing process of the plug. The plug can be field wired or, with the substitution of two molded parts, it can be a smaller factory wired device. The main housing, bottom cover and top cover can be ultrasonically welded to form a unitary member and the wiring chamber sealed to provide a water resistant seal. The PCB can be changed to configure the GFCI to operate in an automatic or manual reset mode.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### DESCRIPTION OF THE DRAWINGS

Other aspects, features and advantages of the present invention will become more fully apparent from the following detailed description, the appended claim, and the accompanying drawings in which similar elements are given similar reference numerals:

FIG. 1 is a top isometric exploded view of a plug according to an embodiment of the invention;

FIG. 2 is a bottom isometric exploded view of the plug of FIG. 1;

FIG. 3 is an end sectional view of the plug of FIG. 1;

FIG. 4 is a top sectional view of the plug of FIG. 1; and

FIG. 5 is a side sectional view of the plug of FIG. 1.

### DETAILED DESCRIPTION OF THE INVENTION

The present invention discloses a wiring device having a GFCI in combination with an integral relay module and internally supported GFCI transformers to form a relatively small right angle plug that can be connected to a power conductor of an electrical device such as an appliance. The plug can be configured to provide several configurations such as 15 amp, 20 amp and 2 blade polarized configurations. The plug can be also configured as ground pin-up or pin-down versions. The plug can be assembled in layers to facilitate the manufacturing process of the plug. The plug can be field wired or, with the substitution of two molded parts, it can be factory wired to form a relatively smaller device. The plug contains a PCB configured with automatic or manual reset circuitry for the GFCI.

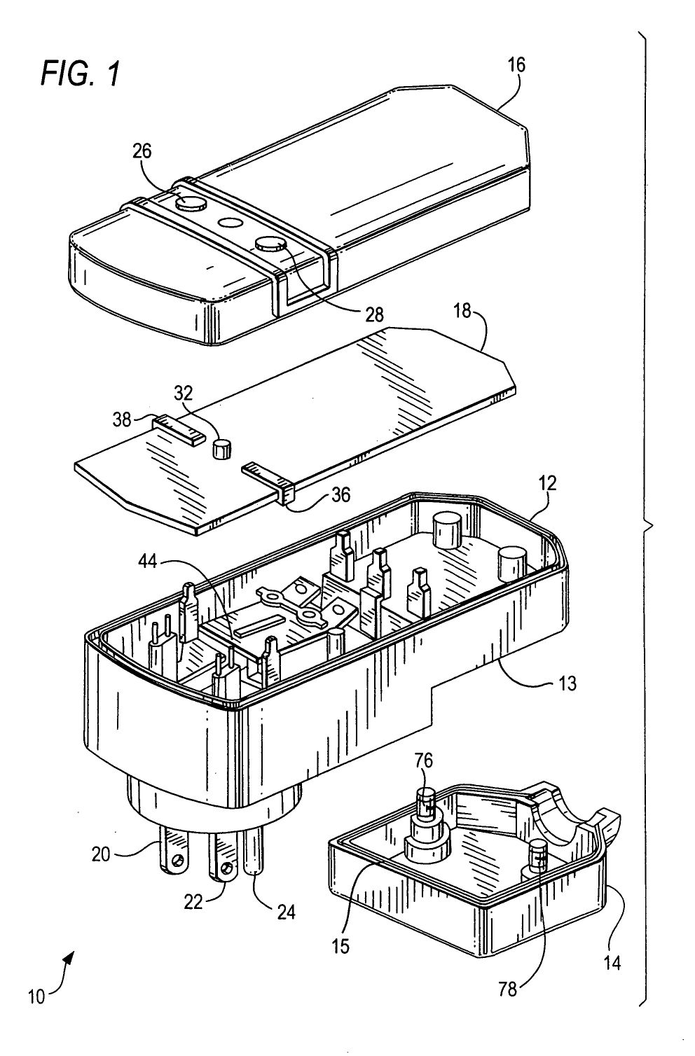

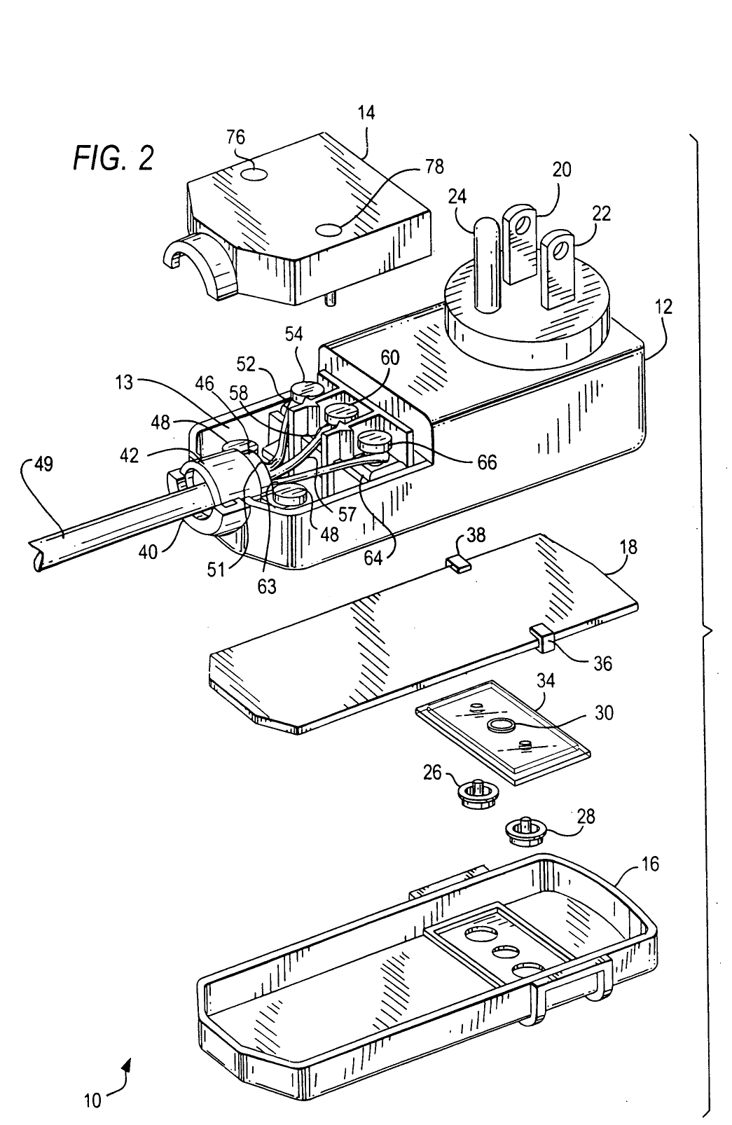

FIGS. 1 and 2 show respective top and bottom isometric exploded views of a plug 10 according to an embodiment of the present invention. Referring to FIG. 1, the plug 10 comprises a main plastic molded housing 12 having a cavity accessible from the top side of the housing for supporting a relay module 44. The relay module 44 is integral with internally supported GFCI transformers forming a right angle plug for connection to a power conductor of an electrical device, as detailed below. Although the description is directed to an angled electrical plug, the disclosed techniques are equally applicable to other configurations such as in-line devices, panel-mounts, and other configurations. Extending from the bottom side of the right angle plug end of the main housing 12, are a phase blade 20, neutral blade 22 and ground pin 24 for connection to a source of alternating current (AC) power such as a receptacle (not shown). The blades 20, 22 and pin 24 can be made of brass or other metal. The bottom portion of the main housing 12 includes a wiring chamber 13 providing terminals for connection to a power cable having conductors such as wires. Information regarding the operation of the plug can be molded onto the main housing 12 to provide a user with information such as instructions regarding the type of electrical cable or wire to use, information indicating which terminals to connect wires to or other pertinent information.

A double sided PCB 18 is electrically connected to the relay module 44 and contains circuitry for performing GFCI functions such as automatic reset or manual reset functions for a GFCI or other functions. The top side of the PCB 18 includes a light emitting diode (LED) 32 for providing an indication of the status of a device connected to the plug such as whether the device is carrying current or whether the device has been interrupted as a result of a ground fault condition, the status condition of the plug or other information. The PCB 18 also includes a pair of reset and test switches having respective flexible arms 36, 38 soldered to the PCB 18 for actuating respective reset and test circuitry on the PCB 18. The reset and test switch arms 36, 38 are flexible conductive brass members which are biased in an open or non-conductive state.

The top side of the main housing 12 is sealed with a plastic molded top cover 16 which supports a test button 26 and a reset button 28 extending through an opening in the top cover. The test button 26 is positioned over the test switch arm 38 to actuate the test switch and thereby activate a test function. Likewise, the reset button 28 is positioned over the reset switch arm 36 to actuate the reset switch. The top cover 16 can be ultrasonically welded to the main housing 12 to form a water-resistant seal. Molded instructions can be provided on the top cover 16, for example, to identify features of the plug such as the test and reset buttons, provide instructions for using the buttons to perform a GFCI test procedure or other information. A plastic molded back cover 14 attaches to the wiring chamber 13 using a pair of screws 76, 78 or other fasteners. As explained in detail below, the wiring chamber 13 provides a means for connecting to a power cable. The back cover 14 provides a water-resistant seal around the chamber 13 by using a flexible molded grommet strip 15 which fits within a groove around the periphery of the back cover 14. Molded instructions can be provided on both sides of the back cover 14 for providing information regarding some feature of the wiring chamber such as, for example, describing the range of wires that can be used, a wire stripping gauge or other pertinent information.

Referring to FIG. 2, shown is the bottom view of the plug 10 of FIG. 1. The wiring chamber 13 supports electrical and mechanical connection to an electrical power cable 49. A flexible molded circular shaped grommet 42 is mounted in a groove at the wiring opening 40 of the wiring chamber 13 to provide a water-resistant seal around the cable 49 and the opening 40. The grommet 42 may have different inside diameters to accommodate various different types of cables. The power cable 49 is secured to the wiring chamber 13 by a strain relief clamp 46 which is fastened to the base of the wiring chamber with a pair of screws 48 or other fastening means. The cable 49 is placed under a centrally located ridge on the clamp 46 to accommodate the thickness of the cable 49.

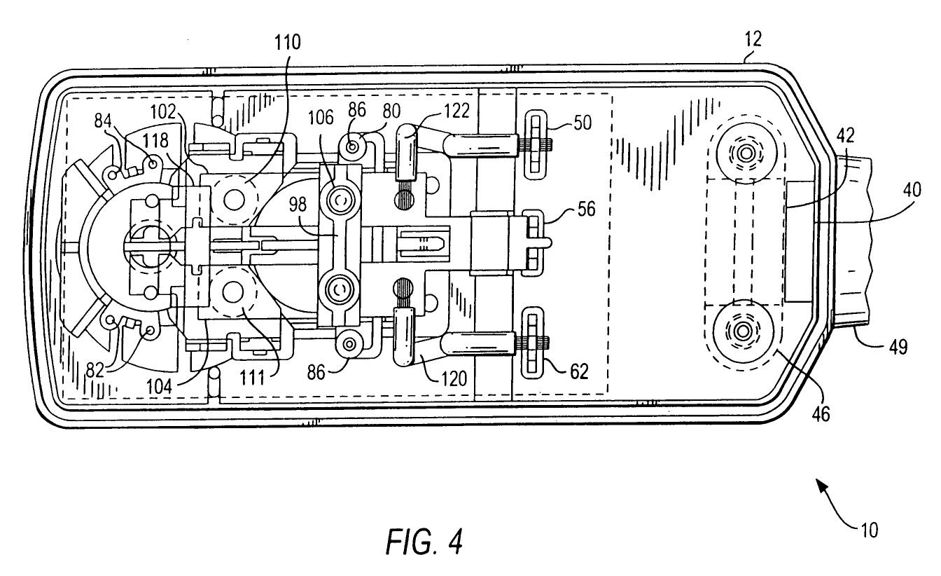

The phase conductor 51 of the power cable 49 is electrically connected to the phase terminal assembly comprising a clamp 52, screw 54 and a terminal (shown as 50 in FIG. 4) disposed under the clamp 52. The threaded portion of the screw 54 extends through a centrally located opening on the clamp 52 and engages a centrally located threaded opening on the terminal. To attach the conductor 51 to the terminal, the conductor can be placed between the clamp 52 and the terminal and the screw 54 is tightened to provide a secure connection. In a similar manner, the ground conductor 57 is electrically connected to a ground terminal (shown as 56 in FIG. 4) using a clamp 58 and screw 60 arrangement and the neutral conductor 63 is electrically connected to a neutral terminal (shown as 62 in FIG. 4) using a clamp 64 and screw 66 arrangement.

The inside of the top cover 16 supports a retainer lens 34 which is a transparent plastic molded part for holding in place the test button 26 and the reset button 28. The retainer lens 34 provides a lens 30 positioned over the LED 32 (FIG. 1) to allow light from the LED to be emitted from within the housing 12. The retainer lens 34 can be ultrasonically welded to the top cover 16 to provide a water-resistant seal. To improve this water-resistant seal, the test button 26 and reset button 28 have seal rings which are compressed when the retainer lens 34 is mounted to the bottom side of the top cover 16.

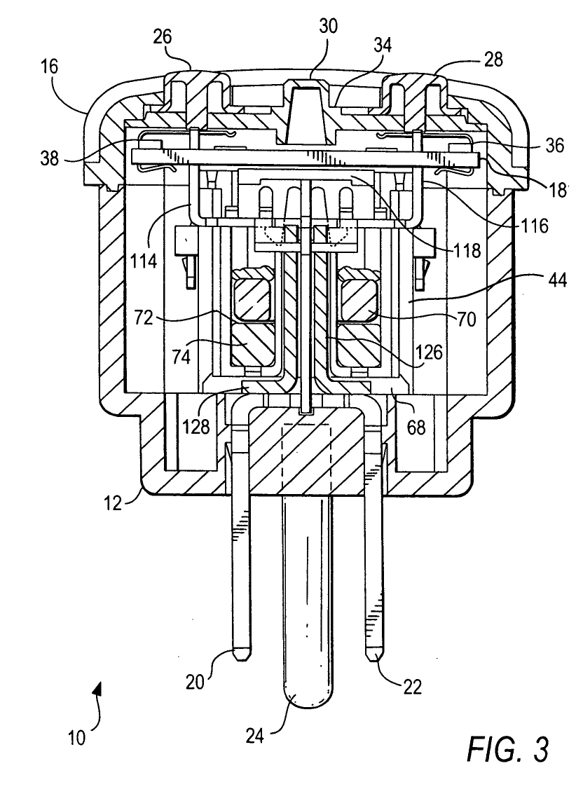

FIGS. 3, 4 and 5 are respective end, top and side sectional views of the plug of FIG. 1. The relay module 44 supports a relay portion and a transformer portion.

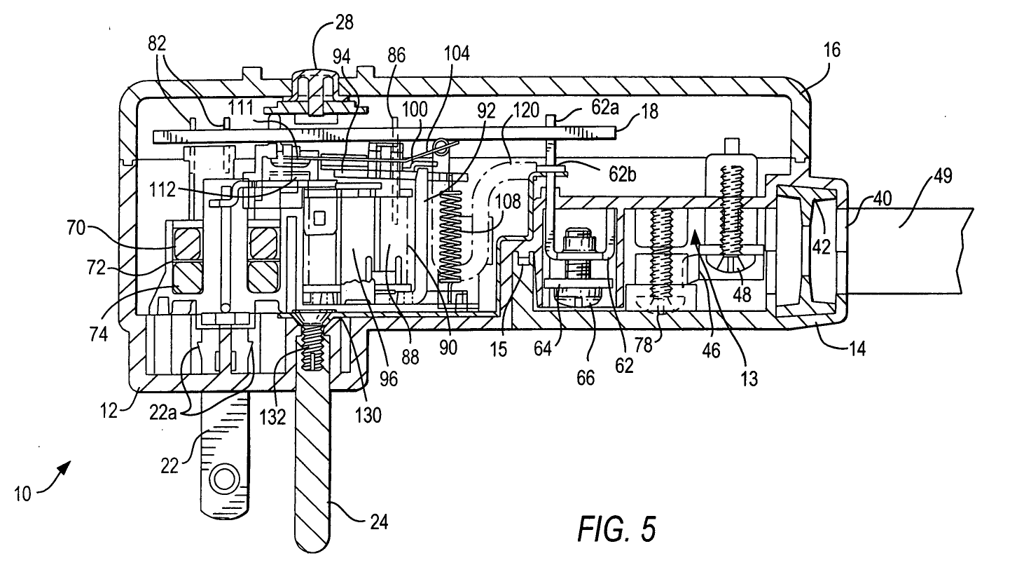

Referring to FIG. 3, the transformer portion of the relay module includes a relay base 68 for supporting a pair of transformer coils 70, 74 forming a stacked arrangement or configuration. In one embodiment, transformer coil 70 is part of a neutral transformer and transformer coil 74 is part of a differential transformer. As known in the art, a neutral transformer detects a low impedance condition between a load side neutral and a ground conductor and a differential transformer detects an unbalanced current flowing through a line side phase and neutral conductor. A washer 72 made of non-conductive or insulative material separates the neutral transformer 70 from the differential transformer 74. The transformer 70 has a toroid core wound with wire having two ends connected to a pair of pins 82 (FIG. 4) for electrical connection to the bottom side of the PCB 18. Likewise, the transformer 74 has a toroid core wound with wire having two ends connected to a pair of pins 84. FIG. 5 shows the transformer pin 82 (pin 84 is not shown) extending through the PCB 18 and soldered to the PCB.

The bottom portion of the test button 26 is located over a top surface of the flexible test switch arm 38 and in contact with the switch. A downward force to the test button 26 causes the flexible arm 38 to yield downward and make electrical contact with a conductive contact pad located on the top surface of the PCB 18. The GFCI circuitry of the PCB responds by activating an appropriate test procedure. The reset button 28 and the flexible reset switch arm 36 operate in a similar manner to the test button and test switch described above and is not described further. The retainer lens 34 holds in place the test button and the reset button assemblies.

The neutral blade 22 and the phase blade 20 are secured to the bottom of the housing 12. In particular, the neutral blade 22 is welded to a solid wire which passes through the transformer coils and soldered to a stationary terminal 116 of the relay module. After the wire is welded to the blade 22, it is pressed into bottom portion of the housing 12. Jagged protrusions or lancings 22a (FIG. 5) on each side of the neutral blade 22 secure the blade to the housing 12. A metal extension member 126 provides an electrical connection between the neutral blade 22 and the PCB 18. Phase terminal 20 is attached to the bottom of the main housing 12 and to a stationary terminal 114 in a similar manner as the neutral terminal 22 as described above. A metal member extension 128 provides an electrical connection between the phase blade 20 and the PCB 18. One of the blades 20, 22 has a fine gauge wire welded to it, compared to the other blade, to connect to the PCB 18.

Referring to FIGS. 4 and 5, in one embodiment, the relay portion is a dual pole single throw (DPST) relay having a pair of movable contact arms 102, 104 for supporting respective upper contacts 110, 111. The upper contact 111 is positioned over a lower stationary contact 112 (FIG. 5) to make contact with the lower contact 112. Likewise, the upper contact 110 is positioned over a lower stationary contact (not shown) to make contact with the contact lower contact. Stationary contact pins 86 extend at a right angle from a support member to allow for connection to GFCI electrical circuitry on the PCB 18. One end of a conductor 122 or wire is connected to the bottom side of the phase terminal 50 and the other end of the conductor 122 is connected to one end of the contact arm 102. Likewise, contact arm includes an opening for connecting a conductor 120 to the bottom side of the neutral terminal 62. A barrier stop 118 made of insulating or non-conductive material such as plastic is positioned over movable contact arms 102, 104 and is snapped onto a support member made of brass or other metal. The barrier stop 118 acts as an upward stop for the movable contact arms 102, 104. The upper contacts 110, 111 and lower contact 112 can be made of a silver composition or other metal alloy. The contact arms 102, 104 can be made of a conductive metal such as beryllium copper or other copper alloy.

The relay is adapted to selectively connect phase and neutral conductive paths between a line and load side (not shown). The line side refers to the side that is connected to a source of power such as AC power from a wall socket and the load side refers to the side that is connected to an electrical load or device. The relay is in one of two states depending on whether the upper contacts 111, 110 are in contact with the respective lower contacts 112 (the other contact is not shown). In a closed state (not shown), the upper contacts 110, 111 are in contact with the respective lower contacts to allow current to flow from the line side to the load side. On the other hand, in an open state, as shown in FIG. 1, the upper contacts 110, 111 are not in contact with the respective lower contacts and current does not flow from the line side to the load side. The upper contacts 110, 111 are in electrical contact with respective lower contacts when the relay is energized during normal operation such as in the absence of a ground fault condition. When the GFCI circuitry detects a ground fault condition, the relay coil is de-energized thereby breaking the connection between the upper contacts 110, 111 and respective lower contacts.

Referring to FIG. 5, the relay includes a bobbin made of nylon forming a round core 96 wound with coil wire 88 and sealed with tape 90 to prevent damage to the wire. The coil wire 88 has two ends connected to respective relay pin pair 86 (also FIG. 4) which is mounted through respective support members extending from an upper portion of the bobbin 80 (FIG. 4). The relay pin pair 86 is adapted to be connected to the PCB 18. A metal core (not shown) passes through a center portion of the bobbin and coil wire 88 to secure the assembly to a relay frame 92. The relay frame 92 is a metal jacket having walls that surround and hold the relay core assembly. An armature plate 94 of metal is disposed over the relay core and hinges at a right angle on a wall of the relay frame 92. The plate 94 is magnetically drawn to the relay core when the relay is energized.

An insulation spacer 100 separates the armature plate 94 from the contact arms 102, 104. The insulation space 100 also includes a rib to prevent the two contact arms 102, 104 from contacting each other. A clamp 98 (FIG. 4) is positioned over the contact arms 102, 104. A pair of metal eyelets 106 or rivets extend through the clamp 98, contact arms 102, 104, insulation layer 100 and armature plate 94 to hold these elements in place. A relay spring 108 provides a mechanical bias as to maintain the armature plate 94 in an upward open position until the relay is energized. One end of the relay spring 108 is connected to a rear portion of the armature plate 94 and the other end of the spring is connected to the base of the frame 92.

As explained above, the wiring chamber 13 includes terminal assemblies for connecting conductors of a power cable to the plug. For example, the neutral conductor 63 (FIG. 2) is connected to the neutral terminal assembly comprising the J-shaped terminal 62 having an extruded threaded opening, the wire clamp 64 and the screw 66. To assemble, the wire clamp 64 is attached to the terminal 62 and the screw 66 is threaded into the openings of the wire clamp and the terminal. The terminal 62 is then pushed through the wiring chamber 13 until a lancing (not shown) on the terminal snaps into a spring tab (not shown) in the housing 12. The top portion of the terminal 62a has a reduced area that is soldered to the PCB 18. The middle portion 62b has a slot that accepts the wire 120 from the contact arm of the relay module and from the ground wire. Underneath the slot, the lancing holds the terminal 62 in place. The other end remains on the wiring chamber 13 and includes the wire clamp 64 which can be used to field wire the plug. The neutral conductor is attached in a similar manner to the phase conductor as described above. The ground pin 24 fits into the bottom portion of the main housing 12 and is held in place on the inside of the housing by crimping it to a ring terminal. The ring terminal is connected to a ground wire that is soldered to the ground terminal 56 (FIG. 4). The inside end of the ground pin 24 is secured to a ground strap 130 by a screw 132 or other fastener.

While there have been shown and described and pointed out the fundamental novel features of the invention as applied to the preferred embodiments, it will be understood that various omissions and substitutions and changes of the form and details of the method and apparatus illustrated and in the operation may be done by those skilled in the art, without departing from the spirit of the invention.

1. A wiring device comprising:
a housing having an opening for receiving a conductor and having blades for insertion into an outlet for receiving a current;
a ground fault circuit interrupter having transformer coils located within the housing; and
a relay module operatively coupled to the ground fault circuit interrupter, wherein the relay module is located within the housing having a set of stationary and a set of movable contacts wherein one set of contacts are coupled to conductors that pass through the transformer coils to the blades.

2. The wiring device of claim I further comprising:
a lens coupled to said housing; and
a light emitting diode within the housing coupled to emit light through the lens to indicate whether current through the wiring device is being conducted or interrupted.

3. The wiring device of claim 1 wherein the housing includes molded in information regarding the wiring device.

4. The wiring device of claim 1 wherein the wiring device is a right angle plug having a top side and a bottom side where the blades extend from the bottom side.

5. The wiring device of claim 1 further comprising at least one button for actuating a switch for activating a GFCI procedure.

6. The wiring device of claim 1 further comprising a grommet having a central opening for receiving the conductor.

7. The wiring device of claim 1 further comprising a strain relief clamp for securing the conductor to the housing.

8. The wiring device of claim 1 further comprising a printed circuit board (PCB) supporting GFCI circuitry.

9. The wiring device of claim 8 further comprising at least one switch responsive for activating a GFCI procedure.

10. The wiring device of claim 1 wherein the housing provides a water-resistant seal.

11. The wiring device of claim 1 wherein the housing has a wiring chamber with terminals for connecting to the conductor.

12. The wiring device of claim 11 wherein the wiring chamber includes a flexible grommet around the periphery of the wiring chamber to provide a water-resistant seal.

13. The wiring device of claim 1 wherein the transformer coils include a first transformer positioned over a second transformer forming a stacked relationship to each other.

14. The wiring device of claim 1 wherein one of the transformer coils is a differential transformer for detecting an unbalanced current flowing through a line side phase and neutral conductor.

15. The wiring device of claim 1 wherein one of the transformer coils is a neutral transformer for detecting a low impedance condition between a load side neutral and ground conductor.

16. The wiring device of claim 1 wherein the transformer coils have a magnetic core with a toroidal shape.

17. The wiring device of claim 1 wherein the pair of stationary contacts and the pair of movable contacts are in contact when the relay is energized.

18. The wiring device of claim 17 wherein the set of stationary contacts are supported by respective contact arm members.

19. The wiring device of claim 17 wherein the set of movable contacts are supported by respective contact arm members.

20. The wiring device of claim 17 wherein the relay includes a relay frame having a top portion for supporting an armature plate.

21. The wiring device of claim 20 wherein the relay further comprises a spring for providing an upward bias to the armature plate.

22. The wiring device of claim 21 wherein the spring has a first end attached to a portion of the armature plate and a second end attached to the bottom portion of the relay frame.

23. The wiring device of claim 22 wherein the relay further comprises a clamp for securing the movable contacts to the armature plate.

24. The wiring device of claim 23 wherein the relay further comprises a bobbin wound with a coil of wire.

25. The wiring device of claim 24 wherein the relay further comprises a rod shaped metal core that passes through a central opening of the bobbin to hold the bobbin to the frame.

26. The wiring device of claim 1 wherein the blades include a neutral blade for connection to a neutral conductor of a power source and a phase blade for connection to a phase conductor of the power source.

27. The wiring device of claim 1 further comprising a ground pin for connection to a ground conductor of a power source.
